(19) United States
(12) Patent Application Publication
(10) Pub. No.: US 2005/0198493 A1
(43) Pub. Date: Sep. 8, 2005

(54) Distribution methods and apparatus for promoting distributed digital content on a local network

(76) Inventor: John Alexander Bartas, Cupertino, CA (US)

Correspondence Address: CENTRAL COAST PATENT AGENCY, PO BOX 187, AROMAS, CA, 95004, US

(21) Appl. No.: 11/097,729

(22) Filed: Apr. 1, 2005

Related U.S. Application Data
(63) Continuation-in-part of application No. 10/665,860, filed on Sep. 17, 2003.
(60) Provisional application No. 60/559,221, filed on Apr. 2, 2004.

(51) Int. Cl. G06F 15/16; H04L 9/00

(52) U.S. Cl. 713/154; 709/217

(57) ABSTRACT

A system for promoting and distributing digital content over a data network includes a source node connected to a data network; a target node connected to the data network; and a server application running on the source node for concatenating digital content for distribution to the target node. In a preferred embodiment, the digital content distributed to the target node is a multipart file including at least an executable replication of the server application, an executable for installation of the digital content, and a module for promoting the existence of the content and new point of distribution thereof to at least one other target node.

### CROSS-REFERENCE TO RELATED APPLICATIONS

The present invention claims priority to a U.S. provisional patent application No. 60/559,221, filed on Apr. 2, 2004 and is a continuation-in-part (CIP) to a U.S. patent application Ser. No. 10/665,860 filed on Sep. 17, 2003. The disclosures of the above applications are included herein in their entirety at least by reference.

### BACKGROUND OF THE INVENTION

1. Field of the Invention

The present invention is in the field of network-based distribution of digital content and pertains particularly to methods and apparatus for enabling commerce-related or no-charge file acquisition and installation of content and utilities to network nodes having connection to a local network from a self-contained electronic package functioning as a self-distribution point.

2. Discussion of the State of the Art

Since the mid-1990s with the advent of client/server software distribution models, software packages have been distributed via data networks, primarily the well-known Internet network, to client nodes connected to the network. In typical models, a client computer node connected to a network and in communication with an accessible server node over the network first sends indication to the server node that it intends to receive particular software. The server node then transmits an executable file to the client node, often after a transaction has been completed with the client node. The executable may contain compressed files and a mechanism or instruction for installing the software at the on the client node. In some instances, the transmitted file may automatically start the installation program to begin the installation process on the client node after the file is downloaded.

One limitation with this model is that the server nodes are typically installed at only a very few sites, usually at the providers web site and a number of “mirror” sites. This model generally requires that the client node download the software over the Internet network using the available bandwidth. Such a path may be typically over slow over a wide area connection such as DSL, dial-up, or Cable Web/TV. Such wide area links are often slow, unreliable, and may be cost inefficient.

Another noted limitation is that the server node responsible as the distribution point of the software cannot proactively promote or advertise the software on local networks. Software providers typically pay large fees to other web sites (or their agents) for web-based advertising to inform the public of software availability and the distribution point or points wherefrom the software may be downloaded. Both of the above-described limitations work to elevate distribution costs and limit the speed and scope of the software distribution network.

More recently, digital content other than executable installation packages has been distributed over data networks. Some of this content may include music or video downloads (for example MP3 files or MOV files), or text and graphic files. In practice, non-executable content that is simply stored and readily displayed through generic client programs has generally not been included in the traditional mode of software distribution. For example, a downloaded music file is a separate file entity from the server software that enables the download. Like wise many companies give software programs to consumers free of charge to spread usage of those programs, which may eventually lead to purchase of upgrades or related products. However, those companies are now limited to traditional distribution points as described above.

The inventor knows of a system, listed in the cross-reference section of this specification as application Ser. No. 10/665,860 filed on Sep. 17, 2003, for providing network security through manipulating data connections and connection attempts over a data-packet-network between at least two network nodes. The system includes a system host machine, a first software application residing on the host machine for detecting and monitoring connection activity, a data store for storing connection related data, and a second software application for emulating one or more end nodes of the connections or connection attempts. In a preferred embodiment the system uses the detection software to detect one or more pre-defined states associated with a particular connection or connection attempt including states associated with data content transferred there over and performs at least one packet generation and insertion action triggered by the detected state or states, the packet or packets emulating one or more end nodes of the connection or connection attempt to cause preemption or resolution of the detected state or states.

It has occurred to the inventor that the ability to intercept an active TCP/IP connection and generate and insert packet data into the stream directed to an end-receiving device could be leveraged in at least secure and controlled network environments to send promotion based messaging to network nodes. However, traditional distribution systems still rely on tedious and often ad-hoc advertising schemes to alert potential customers of products and services.

What is clearly needed in the art is a method and apparatus for distributing software content to and among nodes connected to local computer networks whereby new local distribution points may be dynamically realized and whereby those distribution points may advertise existence to other nodes connected to the network. Such a method and apparatus would enable faster and lower cost distribution of software programs and other commonly distributed media.

### SUMMARY OF THE INVENTION

A system for promoting and distributing digital content over a data network is provided and includes a source node connected to a data network; a target node connected to the data network; and a server application running on the source node for concatenating digital content for distribution to the target node. In a preferred embodiment, the digital content distributed to the target node is a multipart file including at least an executable replication of the server application, an executable for installation of the digital content, and a module for promoting the existence of the content and new point of distribution thereof to at least one other target node.

In one embodiment, the data network is one of a local area network or a wireless local area network. In another embodiment, the data network includes the Internet network and at least one local area network or wireless local area network. In one embodiment, the source node and target node are computing stations. In still another embodiment, the source node is resident to a local area network and the target node is a wireless-capable node temporarily authorized to access the local area network. In yet another embodiment, the source node is a router and the target node is a wireless computer and the network is a wireless LAN connected to the Internet network. In another embodiment the target node is a wireless computer having a wireless connection to a network other than the network that hosted the download to the target node. In one embodiment, the network hosting the target node is a wireless fidelity network.

According to a preferred aspect of the present invention, the system further includes application logic for enabling proactive advertisement of the existence of the digital content the advertisement including the identification of the server of that content from the source node; and a connections database built during active distribution listing the parameters of all active network connections on the local network.

In one embodiment, the advertisement received is an electronic display window received as a result of a browser action performed on the target node. In one embodiment, the browser action is a domain name service request, the request intercepted by the source node using the application logic. Also in one embodiment, the source node emulates the subject server node of the domain name request sent by the target node and resets the server connection.

According to another aspect of the present invention, a multipart file capable of distributing versions of itself to multiple computing devices connected to a local area network is provided. The multipart file includes a server application for concatenating the file including a version of itself for distribution; an installation code for installing the server application and other installable components of the multipart file to each subsequent computing device; a file payload of useful digital content; and application logic for building a database of network connections forged on the local network and for inserting content into those connections by emulating one party of those connections.

In one embodiment, the file is self-executable upon download causing installation of the installable file portions and activation of further distribution efforts. Also in one embodiment, the local area network is an Ethernet network. In one embodiment, the local area network is a wireless network. In a preferred embodiment, the file payload comprises one or more music files, video files, images, software updates to existing programs, software upgrades to existing programs, or new software programs.

In still another aspect of the present invention, a method is provided for distributing digital content over a local network. The method includes steps for (a) intercepting a request to a server from a local node on the network; (b) responding to the request by emulating the server and inserting information into the session, the information advertising the existence of the content for distribution and the network identification of the server of the content; (c) receiving a request from the node responsive to the advertisement inserted; (d) establishing a session with the local node and gathering information; (e) concatenating the digital content including installation, logic, and server components into an executable multipart file; and (f) sending the multipart file to the local node in a file download during the session.

In one aspect of the method in step (a) the request is a domain name service request. In all aspects, in step (a) the local node is one of a resident computer, a wireless laptop, or a network-capable wireless telephony device. In one aspect of the method, in step (b) the connection to the server is reset and emulation of the server is accomplished by generating a packet having the connection parameters of the sending server. In this aspect, the inserted packet is an advertisement for the availability of the digital content including a hyperlink to the available content server.

In one aspect in step (d) the information gathered includes platform type, operating system type, and central processing unit type information. Also in one aspect in step (e) the multipart file is compressed before send. In still another aspect of the method, in step (f) the multipart file self executes immediately after download is complete.

In still another aspect of the present invention, a method for distributing digital content over a local network including steps of: (a) receiving a request to a POD from a local node; (d) establishing a session with the local node and gathering information; (e) concatenating the digital content including installation, logic, and server components into an executable multipart file; and (f) sending the multipart file to the local node in a file download during the session.

### BRIEF DESCRIPTION OF THE DRAWING FIGURES

FIG. 1 is an architectural overview of a communications network wherein software distribution is practiced according to an embodiment of the present invention.

FIG. 2 is a block diagram illustrating a software package and components for distribution according to an embodiment of the present invention.

FIG. 3 is process flowchart illustrating steps for distributing a free software program or file content over a local network according to embodiments of the present invention.

FIG. 4 is a process flow chart illustrating steps for distributing a billable software program or file content according to an embodiment of the present invention.

FIG. 5 is a process flow chart illustrating steps for practicing a music-sharing embodiment.

### DETAILED DESCRIPTION

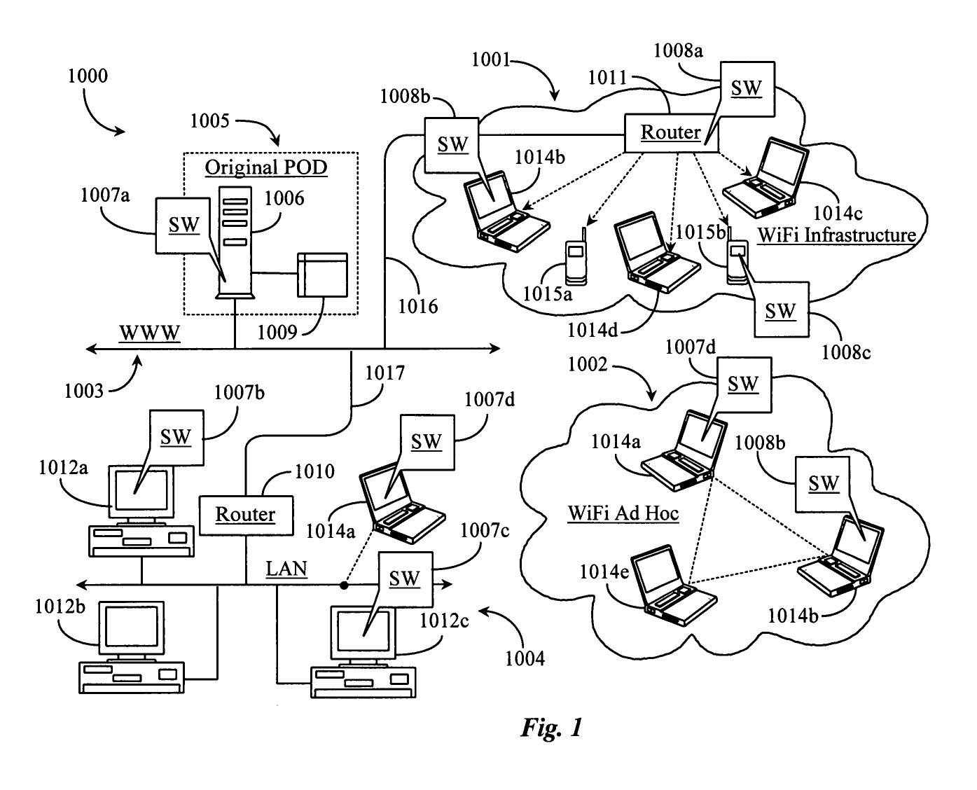

FIG. 1 is an architectural overview of a communications network 1000 wherein software distribution is practiced according to an embodiment of the present invention. Communications network 1000 comprises, in this example, a wireless fidelity (WiFi™) infrastructure network 1001, a WiFi™ Ad-hoc network 1002, an Internet network 1003, and a local area network (LAN) 1004. A WiFi™ network refers to any wirelessly accessible network conforming to the 802.11b or 802.11a or 801.11g and similar wireless standards, which are becoming prominent in distribution, known as WiFi™ access points and are well-known in the art.

Internet network 1003 is represented herein by an Internet backbone (WWW), which represents all of the lines, equipment, and access points that make up the Internet network as a whole. Therefore, there are no geographical limitations to the practice of the present invention. An original point-of-distribution (POD) of media or software for distribution is represented in this example as POD 1005. POD 1005 may be a company-hosted Web domain including a Web server 1006 associated with an on-line database 1009. For example, Web server 1006, connected to WWW 1003, has a software package 1007a resident thereon and represents a self promoting and distributing executable that may install itself at a new distribution point and make that distribution point fully capable of serving additional copies to yet more new distribution points.

POD, for example, may be a company that promotes and distributes some useful software program such as a new Web browser, word processing program, or newsreader, to name a few possibilities. The actual content files making up a package payload of SW 1007a may reside in database 1009. SW 1007a contains all of the necessary utilities for distributing the content and for replicating the necessary utilities to duplicate itself at a new distribution point. A program installation module and a packaged file server (not illustrated here) are included with SW 1007a in addition to optional connection builder and interceptor module and billing and registration components (not illustrated) in order that SW 1007a may be distributed to a node other than server 1006 such that the receiving node may optionally become a new server of the SW.

LAN 1004 has connection to WWW 1003 by virtue of an Internet access line 1017 through a router 1010. LAN 1004 may be a public or private network and is, in this example, enabled for TCP/IP communication. LAN 1004 supports a plurality of connected desktop computer nodes including a computer node 1012a, a computer node 1012b, and a computer node 1012c. Computers 1012(a-c) may be considered resident LAN network nodes and one with skill in the art of LAN networking will appreciate that there may be many more computer nodes included in LAN 1004 without departing from the spirit and scope of the present invention. Each computer 1012a, 1012b, and 1012c, in this example has a LAN network card that uniquely identifies the respective node on the network including a machine access code (MAC) address. Typically, am Ethernet network driver provides network function for each connected node.

A wirelessly operated laptop computer 1014a is illustrated in this example as having a temporary wireless access connection to LAN 1004. Laptop 1014a is mobile and may forge connection to LAN 1004, interact with other LAN-connected nodes as well as other network services and then log-off and disconnect. When laptop 1014a is connected to LAN 1004, it receives a temporary network address so as to be uniquely identified on the LAN for communication and may enjoy the same privileges as the other resident computer nodes. Laptop 1014a typically has a wireless-capable network card (not illustrated) adapted for the purpose of enabling wireless LAN access through router 1010, or through one of nodes 1012(a-c).

To distribute SW 1007a from server 1006 to a point of LAN 1004, for example, a node connected to LAN 1004 must have access to server 1006 over Internet 1003 in order to receive the package. In typical distribution of media and software, server 1006 might be the only available distribution point through which available content might be downloaded to another node. However, in accordance with an embodiment of the present invention, SW package 1007a is adapted to install itself on another node and takeover as an additional distribution point option for other requesting nodes. To practice software distribution from Internet 1003 to LAN 1004, consider that computer node 1012a has accessed server 1006 (the original POD) through router 1010 and Internet access line 1017, which may be a 100-based T line for example. After performing the appropriate connection and negotiations, computer 1012a has acquired a copy of package 1007a, which is illustrated on computer 1012a as a SW package 1007b.

Now computer 1012a is a new point of distribution (POD) for the content and the content may now be distributed locally to all of the other nodes connected to LAN 1004 without requiring any further connection to Internet 1003 and server 1006. As described above, this is made possible through use of a self-replicating file server and installation utility, which are part of SW package 1007b, optionally making computer 1012a a local POD for the SW. According to one embodiment, computer 1012a upon receiving and installing package 1007b has the power to further promote and distribute the package using a level of promotional messaging capability that may optionally range from passive to aggressive promotion of existence of SW 1007b and the associated file server as a new source for the content with reference to any of the other LAN connected nodes.

In this example, computer 1012c on LAN 1004 has accessed computer 1012a over the LAN to receive SW 1007c, which is identical to SW packages 1007b and 1007a. Optionally computer 1012c may now promote itself as a new source for the package to other local computers connected to LAN 1004. However, this may not be required in order to practice the present invention, which may call for distribution strategies that may be related to the content of the package and to the nature of the enterprise hosting LAN 1004. For example, LAN 1004 may host up to 100 computer nodes all of which may be dedicated for the same purpose in business and all of which may be required to consume the content of package 1007b. Package 1007b may be an update to the operating system shared by all of the computers on the LAN, for example. Moreover, the update may be exceptionally large like a service pack of considerable megabytes, perhaps 100 or more.

In an embodiment such as described above, an aggressive promotional approach may be practiced by new PODs on LAN 1004 until all resident computers on LAN 1004 have been updated. Such an aggressive promotion process, which will be described in more detail later in this specification, may be simultaneously implemented from each new POD, as they become active distributors, aggressively distributing to more LAN-connected nodes until every system is updated and running the new service pack. This type of proactive promotion and distribution activity also enables each system to be updated automatically with no human intervention other than accepting the proactive solicitation offer received from a POD on the network, which may be of the form of a message window with a hyperlink to the server responsible for inserting the message window into the recipient nodes active browser session.

In one embodiment of the invention, any temporary LAN resident node such as laptop 1014a may also be proactively solicited to receive a SW package unless expressly excluded in enterprise rules created for the purpose. That is to say that certain LAN-connected nodes may be excluded from certain updates like a service pack, for example. However, in an embodiment where SW 1007a is a free browser application, for example, laptop 1014a may have the opportunity to download the browser and to become a new distributor for the same. The author of the browser software, in this case, domain 1005 may offer some incentive or benefit for agreeing to further distribute the browser in addition to accepting it as a new installation. In this case, the author enterprise may be particularly interested in soliciting local nodes such as laptop 1014a because of the mobility factor.

Laptop 1014a has SW package 1007d installed and is, for the purpose of this example, a new POD for the package. Because laptop 1014a has wireless capabilities and is mobile, it is an attractive component in the overall distribution process and plan such as may be in practice from domain 1005. Laptop 1014a having SW 1007d for further distribution is also illustrated in this example as a wireless node in communication with other wireless nodes making up network 1002, which is defined as an ad hoc network wherein no router or gateway is present or required. In network 1002 all computer nodes joining the network communicate directly with each other. Other communicating nodes within network 1002 include a laptop node 1014e and a laptop node 1014b. Laptop 1014a may proactively or passively advertise the existence and availability of package 1007d to any other nodes, namely nodes 1014e and 1014b, and distribute the package thereto and also set up the recipients as new PODs for the package.

In this example, network 1002 has a participant laptop 1014b illustrating a SW package 1008b. Package 1008b may be identical to 1007 a-d, but may have arrived within network 1002 from another route. For example, laptop 1014b is also illustrated herein as a wireless participant in network 1001, which has an infrastructure connection to Internet 1003 through a wireless router 1011 and an Internet access line 1016. In this example, router 1011 has a SW package 1008a installed thereon and may be considered a second POD level from POD 1005. In this case, SW 1008a may be a version of SW 1007a adapted to be promoted from and accessible directly from router 1011 in cooperation with a wireless carrier such as T-Mobile™ for example.

Network 1001 is exemplary of a wireless hot spot, as they are known in the art. Such a wireless hot spot enabling Internet access may be one at a coffee shop, an airport, a hotel, or any other implementation that includes a gateway router. Laptop 1014b has acquired SW package 1008b, in one embodiment, directly from router 1011 such that SW 1008b is a distributed replication of package 1008a. In another embodiment, however, router 1011, like router 1010 in network 1004 is a neutral device and instance 1008b is just a replicated and distributed version of SW 1007a acquired for download by laptop 1014b by navigating to original POD server 1006 through router 1011 and access line 1016 while browsing the WWW. Proactively speaking however, laptop 1014b may have acquired SW 1008b directly from router 1011 has an original POD whereby instance 1008b is a replicated version of instance 1008a.

Infrastructure mode in WiFi™ communication allows for a possible network situation in which local wireless nodes may communicate with each other in ad hoc mode and may communicate with other nodes over a wired network infrastructure such as Internet network 1003 in this example, or LAN network 1004 if the access point (AP) router 1011 has a wired connection to LAN 1004 (connection not illustrated here). Likewise, more than one type of device may participate within network 1001 such as a network-capable wireless telephone 1015a and a network-capable wireless telephone 1015b. Telephones 1015 a and b have network browser application installed thereon and may, like any other network-capable device, browse the Internet and receive software downloads for installation. Therefore, telephone 1015b is illustrated as having a version of SW 1008a illustrated in this example as SW 1008c.

SW 1007a and 1008a may be originally packaged using extra files and utilities versions, or by Java technologies to incorporate a variety of computing platforms, operating system versions, and CPU types (device type variances) without departing from the spirit and scope of the present invention. Therefore, distribution of SW 1007a and 1008b may take place between disparate systems without interruption of automatic installation and proactive promotional processes if those are part of the host's distribution scheme, which will be explained in more detail latter in this specification.

In a preferred embodiment of the present invention using both wired connections and wireless connections, SW package 1007a, for example, may be very quickly distributed to a large number of nodes. Unlike traditional software distribution over a network, the numbers of PODs increase dynamically and as each new POD is added to the scheme, down line activity (further distribution) may be tracked to gage the success of a campaign and to quickly build new customer bases for enterprises authoring the distributed software. In one embodiment, the software for distribution is a mandatory software utility replacement, upgrade, or update. In another embodiment, the software for distribution is an e-commerce product for sale to consumers like an audio or video studio application or media-publishing software. In still another embodiment, the distributed content consists of media files for entertainment purposes that may be sold to consumers like pictures, screensavers, movie files, and audio files. There are many possibilities for distributed content as well as variant levels of promotion to further effect the goal of mass distribution.

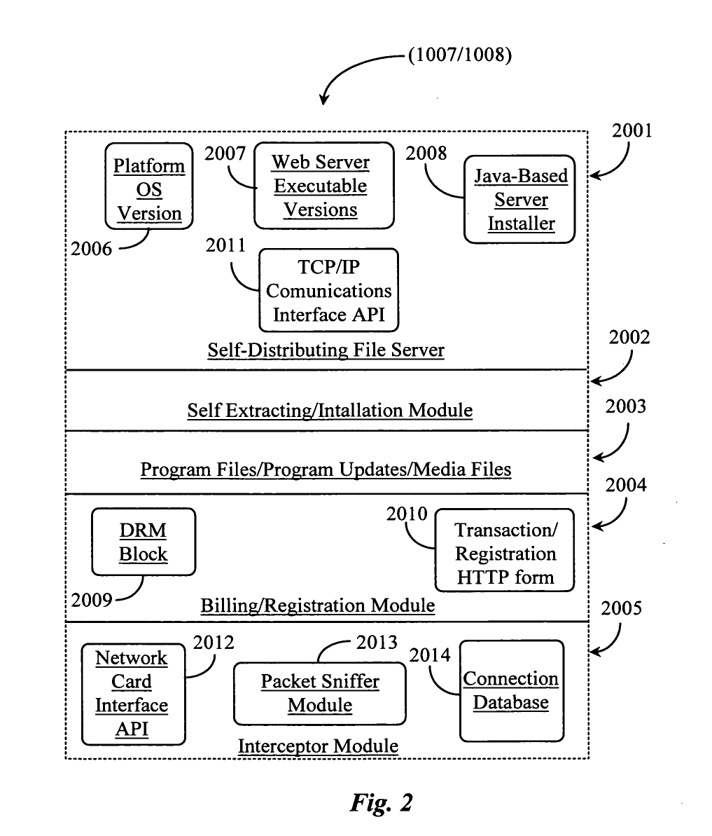

FIG. 2 is a block diagram illustrating components of software package 1007a or 1008a for distribution according to embodiments of the present invention. Package 1007/1008 is a server-concatenated software package that may be downloaded in distribution as one large multipart file. As described further above, packages 1007a and 1008a including all subsequent versions illustrated with respect to FIG. 1 may be virtually identical to one another in terms of component capabilities. Therefore reference to package 1007a shall also refer to package 1008a described with reference to FIG. 1. Package 1007a includes a self-distributing file server 2001. Server 2001 replicates itself each time it is distributed so that every new POD has it's own file server application that may be used to further serve content to subsequent nodes. Server 2001 may be a Web server, a file transfer protocol (FTP) server, or another type of supported content server. In a preferred embodiment, the file server is a Web server because of it's universally supported format and because no client applications other than widely available Web browsers are required to access it and to invoke service from it.

In this example, server 2001 has a platform determination module 2006 for determining at the time of an active connection to a recipient, which platform the recipient device is running and, which operating system (OS) version the platform is running. Based on the information collected by module 2006, an appropriate executable Web server version 2007 of available file server versions stored with or associated to the package is invoked to serve the rest of the package. Like wise the appropriate server version for the running platform, device type and OS version are replicated for download as part of the installed utility for the recipient computer. Therefore, depending on the recipient device characteristics the package has the capability of determining the best file server application to serve files to the next POD. In a preferred embodiment where multiple file server options are available, all of the available server files become part of replicated package 1007a on the next POD. Optionally, server 2001 has a Java-based server install utility 2008. Utility 2008 actually builds the appropriate file server version for serving the package to a recipient computing device in a runtime environment based on the characteristics and needs of that device that may be known and perceived. For each distribution then, the file server also preserves itself on the sending node (POD) and installs a replica itself to the recipient node to extend the reach of distribution by adding another POD if appropriate under existing circumstances.

In one embodiment, Web server 2007 is integrated with an interceptor module 2005 adapted to intercept domain name service (DNS) requests and other data packets generated in communication between local nodes and other machines or applications. Interceptor module 2005 can detect which machines on the LAN do not have package 1007a and can parse requests sent to other machines and applications, including remote nodes to determine if the machine browser is actively looking for content similar to that offered through package 1007a. For example, if a LAN node sends a domain name request having the name of a particular software upgrade, for example, whereby the sought after upgrade is available through the server of package 1007a, then the host machine may insert a message containing the IP address of the host server (POD) emulating the machine hosting the original domain of the intercepted request. The actual practice of intercepting machine requests and resetting connection attempts is described in detail in application Ser. No. 10/665,860 filed on Sep. 17, 2003, listed in the cross-reference section of this specification. The described capability is optional and not specifically required to minimally practice the present invention in passive mode.

Package 1007a has a self-extracting installation module 2002 provided as part of the package and adapted for installing all of the critical files of the package with reference to its intended use. Server 2001 determines which installations will be part of a new package version downloaded to a next computing device and may concatenate installation module 2002 appropriately. For example, product installers, server installers, and interceptor component installers may all be concatenated into one installation sequence. The installation files as well as the content and component files to be installed may all be compressed into a Zip file or other compressed format for transport wherein the installation self extracts after download automatically, or optionally, when the operator executes the downloaded file.

A content or payload 2003 is provided as part of package 1007a and is adapted to point to by reference or to physically include all of the program updates, media files, as well as other possible content that will be sent to the next computing node. It is important to note herein that the content is preserved in the distributing node so that it may be downloaded numerous times from one node using the file server. In the case of the content reference pointing to actual content, the actual content is stored locally at each new POD in internal or in an associated memory adapted for the purpose. All of the content that requires installation on the recipient device is installed by module 2002.

In one embodiment of the present invention, modules 2001, 2002, and content 2003 are all that is required for a self-contained package and installer that may set itself up as a new point of distribution each time a new location occurs. In the most passive case regarding self promotion, there may be included an interface to the new device network card if LAN or WLAN capable, such that while operating on a network, the new POD may receive network requests from other local nodes on the network in reaction to some promotional email, instant message, or other communication received containing a universal resource locator identifying the new file server application on the new POD for the content. In the most passive promotional case, the package itself is not the source of the promotional messaging.

Optionally, package 1007a further includes a billing and registration module 2004 that is replicated at download. Module 2004 enables a new recipient to pay for and/or register a newly downloaded package version from the point of its new location on the recipient's computer. In some distribution modules, billing and software registration may be required. In one embodiment, the distribution rules may allow for a user to manually select, at the time of download of the package, whether or not the user will distribute the content on to other nodes. The option may be linked to billing. For example, before download occurs during a connection between a recipient node and a POD an indication may be presented for display that informs the user that if he or she is willing to be published as a source for the package, he or she will not be billed for the content or for future downloads and upgrades or even related products or services. In this case, the user may select an icon that reads, “enable distribution capability” in case he or she is agreed. An icon labeled “disable server” may be selected if the user just wants the content and is willing to pay not to be a distributor. A user may also be enabled to activate the file server capability through a configuration interface (not illustrated) if he or she wishes to become a source for the content at a latter time.

Module 2001 may contain a TCP/IP communications interface application program interface (API) 2011 for leveraging the devices communications ports and capabilities. In one embodiment a separate communication stack may be provided and may be assigned a communication port of the host device. A transaction/registration hyper test transfer protocol (HTTP) form 2010 may be provided within module 2004 for enabling transaction interaction and registration interaction after downloading the package. Additionally, a digital rights management (DRM) tracking block 2009 may be provided for distribution and consummation of copyrighted materials like music or software code. In one embodiment where music is distributed, for example, a recording artist may grant unlimited downloading of his or her music using a specific device provided that certain new titles samples are distributed freely from the same computing device as a new POD in order to get the word out about the new recordings created by the artist that are for sale. Of course, an intermediary record label promoting the artist may broker the artist's wishes. In such a scheme it may be desired to quickly spread the sample titles through free distribution soliciting new PODs as distribution continues wherein each new POD may be authorized to download certain tracks for free from a central music site in exchange for participating in the distribution campaign of the incomplete music samples of those tracks.

SW package 1007a or 1008a may include interceptor module 2005 mentioned further above, which may be used in an aggressive and proactive distribution scheme. Interceptor module 2005 leverages a technology known to the inventor and described with reference to co-pending application Ser. No. 10/665,860 filed on Sep. 17, 2003. The technology as used in application Ser. No. 10/665,860 filed on Sep. 17, 2003 serves to prevent certain unsafe connections from being established from the protected local network to remote systems and to prevent viruses, Trojans, hacking attempts, Spam and other malicious events from being received by a network node on the protected local network. This is accomplished in one example through real time connection parameter aggregation and logging and then preempting an active network connection or connection attempt, resetting the connection on the server side and subsequently emulating the server of the connection inserting specific content into the open session. The recipient browser receives the inserted content and the browser assumes it has been received from the original server node defmed in the connection parameters.

Interceptor module 2005 is not specifically required in order to practice the present invention, but may be required for accomplishing the most aggressive embodiment of self promotion regarding advertising the existence of a new POD and availability of the package content sourced from the new POD. Interceptor module 2005 has a network card interface application program interface (API) 2012 to its host Ethernet card. API 2012 enables the module to see all other network traffic on the local network while the host device is operating in “promiscuous mode”, which is an available setting on the cards supporting software. Any network-connected device may thus see all of the other devices and session activity taking place between those devices by passively intercepting and monitoring all of the data packets being sent over the network.

In one embodiment, a new POD may advertise its existence to other nodes by waiting for a packet sent by another node that might suggest that the node in question is looking for content similar to that which may be downloaded from the new POD such as by intercepting DNS requests sent from local nodes. In this embodiment, a packet sniffer module 2013 is provided and adapted to detect network traffic and to build a database, referred to herein as a connections database 2014 that logs all of the active session parameters defining active connections between local and remote nodes. The database, which may be a temporary one in flash memory, enables identification of the nature of connection attempts made by local nodes issuing a domain name service (DNS) requests to establish connections to remote nodes or applications. Module 2013 may monitor and intercept packets and parse such as header information and so on. For example, module 2013 may intercept a packet from a local computer that contains one or more URLs returned to a computer as the result of a search request. The search criteria might be content relative to content offered by the host POD. Module 2005 may then generate a message packet containing a URL to its own server (module 2001) and insert the message into the session such that it executed and displays on the recipients device while resetting the connection at the side of the remote server. The recipient may then interact with the URL forming the new connection to the POD enabling distribution of the package to the recipient and optionally creating another POD.

The level of self-promotion depends on enterprise rules and the environment where distribution occurs. For example, on a corporate LAN where all nodes are required to download a distributed content, then the first local POD may generate and send packets to all other detected nodes when they first log on and attempt to form a network connection. In a most proactive mode, no other local node may form any other connections before forming one to the local POD and accepting the download and self install. If only one POD is to be used on a network, then all other servers distributed to the other nodes on the same network may be deactivated by default.

In another embodiment, the servers are left active in distribution of the package from a first POD on a local network. Each node subsequently receiving and installing package also becomes a POD and actively promotes to nodes detected that have not yet received the download until all of the nodes on the network have working instances of the package and are active are PODs for the package. This case is usefull when there are a significant number of nodes on the LAN and perhaps where the installation time of the package may also be significant for each node. As more PODs become active, the subsequent network activity may be load-balanced among them through division and allocation among them of requests left to serve. As a new POD becomes active, it takes its share of the load and there is one less node to consider. This can be accomplished through table sharing and updating. Eventually all of the nodes are served and no PODs are actively promoting to any local network nodes unless one is added to the network permanently or temporarily that does not have a package. In this case, resident nodes on the network may, over time, experience several upgrades and a new node added to the network may be automatically detected and then updated repeatedly by being prompted to download each upgrade it does not already have, the upgrades may be served by any of the other current nodes functioning as a POD for all of those upgrades.

One with skill in the art of network sessions will readily agree that packets carrying payloads may be inserted into a network session by intercepting a packet sent and then responding to the sent packet emulating the sender. In a still more proactive promotion, the invention may be practiced in terms of promoting the existence of content and a new content server (POD) by exploiting an available weakness or flaw in a browser component or communications port much the same way as Trojans are sent to unsuspecting users. However, it is the intent of the inventor in most preferred embodiments, that each user/node that receives a notification of content and identification, URL or other from a server (POD) of that content, be presented with an option to proceed to interact with the new source, receive the content, and optionally be enabled to elect to sign on as a new POD source for the content. However, different embodiments of the invention lend themselves in part to the environment(s) in which the distribution method is practiced, the nature of the content served, and enterprise rules attributed to the process as a whole.

In each case of distribution (download of an existing package to a new node), it is the server 2001, which concatenates the rest of the package for download and installation. The end result is a multipart file that may be downloaded and executed to install the package as a self-promoting and distributing package to the recipient node. In the case of tracking the number of downloads and installs, there are many possible scenarios. In one embodiment, the original POD may also host billing and registration services as well as DRM services for enabling use of the product content. In this embodiment the original POD may log all of the billing and registration activity as new user's login to activate their software. In this case, redistribution may be deactivated until the newly distributed package is counted. In another embodiment, each POD logs the number of downloads from its host machine of the package and periodically reports those to a central server operated by the package author. In this way, the success of a distribution plan may be assessed.

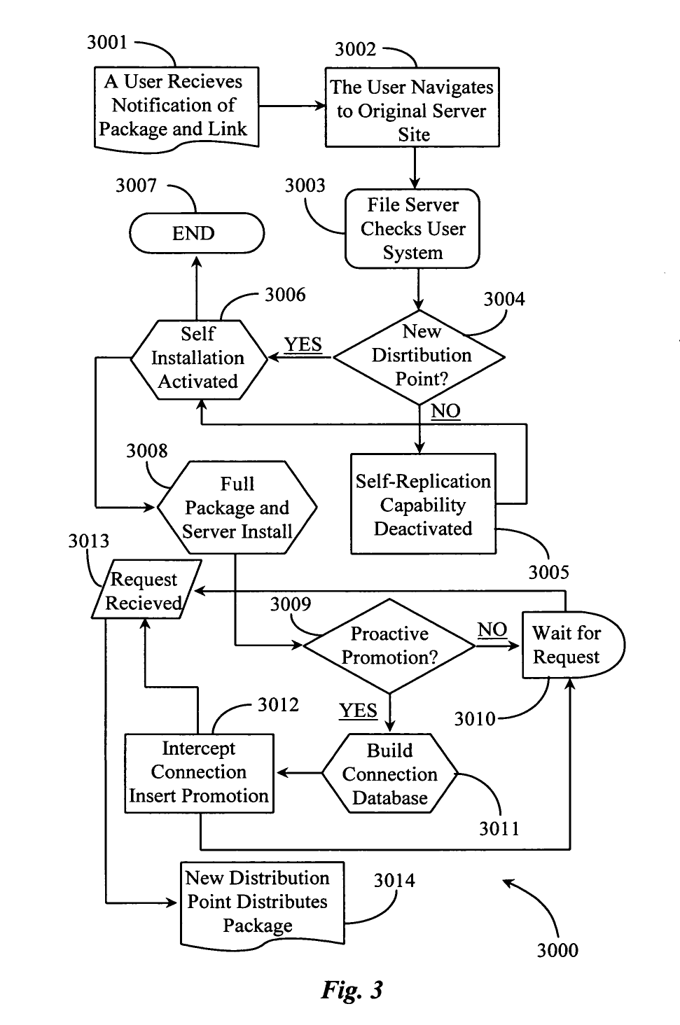

FIG. 3 is process flowchart 3000 illustrating steps for distributing a free software program or file content over a local network according to embodiments of the present invention. At step 3001, a user receives notification of the existence of a package along with a navigable hyperlink to the server associated with the package instance. The notice itself may be an automated message or popup sent during a browser session between the local node and a remote server that has subsequently had its connection to the local node reset by an interceptor module analogous to module 2005 described above.

The user clicks on the link causing browser navigation to the originating server at step 3002. The original server is defined as the package server application (2001) of the POD established as the node that inserted the promotional notification at step 3001. At step 3003 after the connection is established, the file server, which may well be a Web server, checks the user system to determine platform, operating system version, and so on. This is done to ensure that the appropriate versions of the package components including the server, installer, and content, are defaulted for that system. It is noted herein that devices on a same LAN may vary in device type, method of connection, platform, and OS version. In these instances, it is important that the default installation set for the receiving system is supported by the receiving system.

In one embodiment, after checking the user system, at step 3004 an HTTP message may be sent and displayed as a popup window, instant message, simple messaging service (SMS) message or another type of system alert or notification asking the user if the machine can be a new distribution point for the content. If the user declines in this embodiment, the self-replication capability for the server, installer, and content may be deactivated at step 3005. However, the server software, installation software and the content may still be installed. The user may at some later date, activate the self-replication capability and at that time the user may commit the device as a sever of the content.

If at step 3004, it is determined that the new device will be a new distribution point, then at step 3006, self installation is activated assuming that the package has been downloaded. In the event that self-replication is deactivated as in step 3005, the process still resolves to step 3006 for invoking the installation. If the new recipient of the package will not be a distributor then the process may terminate at step 3007 once the user has all of the requested data. In one embodiment, the full package may not be installed if the server understands during concatenation that the new user will not be a distribution point. If the machine is to be a new distribution point then at step 3008, the full package and server is installed. Alternatively, the full package may be installed including the server even though the user has not agreed to be a point of distribution. In this alternative embodiment, the replication feature may be turned off or deactivated by default.

If it was determined that the new install is also a new POD at step 3004, then at step 3009 a determination may optionally be made regarding the level of promotion of itself that might be configured or implemented according to rule. In one embodiment, the self-promotion mechanism is pre-determined and cannot be altered. In another embodiment a user may configure it. In still another embodiment, there are at least 2 options for selecting a promotion method, proactive or passive. In this step, the determination of proactive or not is made, preferably by the system after consulting an instruction or rule. In a proactive promotion, the new POD can insert promotional messages into active data connections that it is originally not a server to. In a more passive scheme, the POD waits until a DNS request or similar solicitation is sent out from a local node, the request to a server known for serving content that is relevant to the package content. In this case, the POD may intercept the request, reset the server, and become the content server. In a most passive scheme, the POD simply waits until it is contacted expressly for the purpose of downloading the package. In this case, the promotional message or notices are sent to all of the prospective local nodes via email or some other messaging program.

If at step 3009 the promotion is aggressively proactive, then at step 3011 the “interceptor” logic operating in promiscuous mode on the LAN builds a connections database as connections are formed. At step 3012, the interceptor may, using the connections database for reference, intercept data requests to other nodes or applications and insert promotional messages emulating the server party of the connections established. Typically the server connections to those local nodes are reset leaving the POD as the new server node. At step 3013 then a request to the host server of the package may be received and the package may be distributed. In a most aggressive mode, the local machine automatically connects to the POD without user input. However, in a less aggressive embodiment, the promotion contains a hyperlink that must be activated by the user before the request can be received at step 3013. Therefore, in this embodiment, the POD may wait at step 3010 for the user to activate the link and navigate to the POD.

If at step 3009, it is determined that no proactive promotion involving packet interception will be practiced, then at step 3010, the POD simply waits for a request to download the package. In this case there may be no self-promotion from the POD. In other words, the local nodes on the LAN may simply be solicited through messaging or email generated and sent by the author of the package from a remote server and the server address to the most local POD to those email or message recipients may be included enabling users to navigate to the POD if they so desire to acquire the package. At step 3014 in all three cases, the POD distributes the package after receiving a request from a local node.

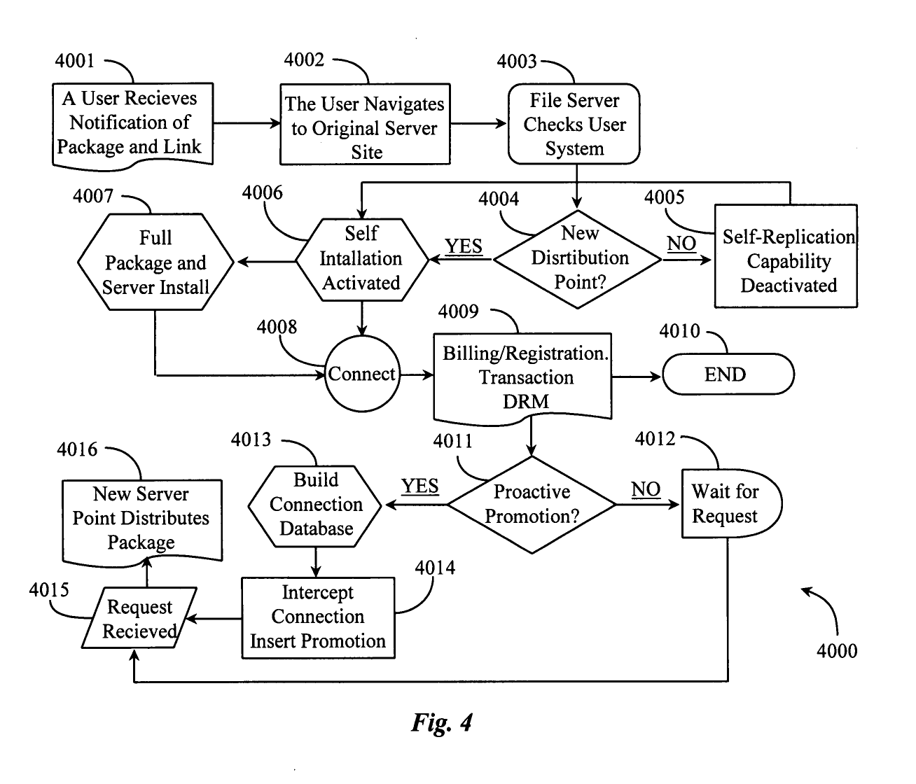

FIG. 4 is a process flow chart 4000 illustrating steps for distributing a billable software program or file content according to an embodiment of the present invention. At step 4001 a user on a local network receives notification of the existence of a package and a link to the server of that package. The user navigates to the original server hosting the package download at step 4002. At step 4003, the file server, which may be a Web server, checks the user's system for platform, OS version, CPU type and so on. This is to ensure that the appropriate installation, server, and content file versions are installed. It is noted herein that the package may contain files of type for any supported platform, OS, and device type. A windows-based computer could distribute to a Linux-based computer, which may in turn distribute to a windows based system.

At step 4004 it is determined if the new location will be a distribution point. This determination may, in this example, hinge on billing and may require user input. For example, an HTTP form may be downloaded and displayed that asks the user if he or she will agree to be a POD in exchange for a lower price or, perhaps a free initial installation. If at step 4004 the user declines to be a distributor, then at step 4005 the self-replication capability may be deactivated until such time that the user may elect to distribute. In the event that step 4005 transpires, then at step 4006 self-installation may be activated after download. If at step 4004 the user agrees to be a distributor, then at step 4006, self-installation is activated after download. In one embodiment, the software automatically installs at the time of download without user intervention. In another embodiment, the user may be required to select the multipart file and execute it after it is downloaded to begin the installation process. It is noted herein that installation may include server installation, content installation (if required), and interceptor program or module installation so that the new package may actively promote and distribute itself to a next computing node.

At step 4007 then a full server and package installation occurs. In this example, at step 4008, the new installation causes a network connection to a billing registration server. At step 4009, any transaction for purchasing the content, registering the content, or activating the content may be conducted over the established network connection. If the client makes a full payment and registration and has been determined at step 4004 not to be a distribution point, the process may terminate at step 4010. However, if the client is to be a distribution point, at step 4011, it is determined if proactive promotion will be practiced. In this case, interceptor logic would be employed. If no proactive promotion will be practiced by the new POD then at step 4012, the machine may simply wait for a request addressed to the server hosting the package for further distribution. If at step 4015 a request is received, then at step 4016 the new server functioning as a latest POD on the network may distribute the package to a next node.

If at step 4011 a proactive promotional course is prescribed, then at step 4013 interceptor logic establishes a connections database. At step 4014 utilizing data from the connections database, the new POD may intercept a request made over an active connection, or, perhaps a connection attempt earmarked by intercept of a DNS request and may insert a promotional message into the connection. The recipient computing device receives the inserted content as if it were sent from the original server subject of the DNS request or from the remote server that was originally in communication with the requester. Typically, the server subject of the intercepted request is reset using a TCP server reset packet. Thereafter, the promotional message displays for the user and the user may select the provided link causing a request received at the POD at step 4015. At. step 4016, then the new server distributes the package to the requesting node.

It will be apparent to one with skill in the art that the same process and process variants exist in both process flows 3000 and 4000 with exception to the billing and registration step and the connection step for enabling the session over which the billing transaction or registration process may be conducted. However, both processes may vary somewhat in the number of steps practiced and in the order of those steps occurring without departing from the spirit and scope of the invention. For example, a billing transaction may be conducted before an actual download and may then be forwarded to a service by the server application after the package has been distributed to a next machine. Also as described further above, the options, if any for self-promoting and for electing to distribute may vary according to design and may depend in part on the environment of distribution, for example, on a private network verses a publicly accessible network.

On a private network for some implementations there may be no human intervention allowed at all. The package may distribute itself arbitrarily until all nodes on the network have the content installed on them. In this case there are no options. However in a public network where users are sensitive to invasive procedures, less proactive distribution measures may be in place, which offer the human operator of a targeted node the option of accepting or declining an offer to download the content and become a distributor of the content.

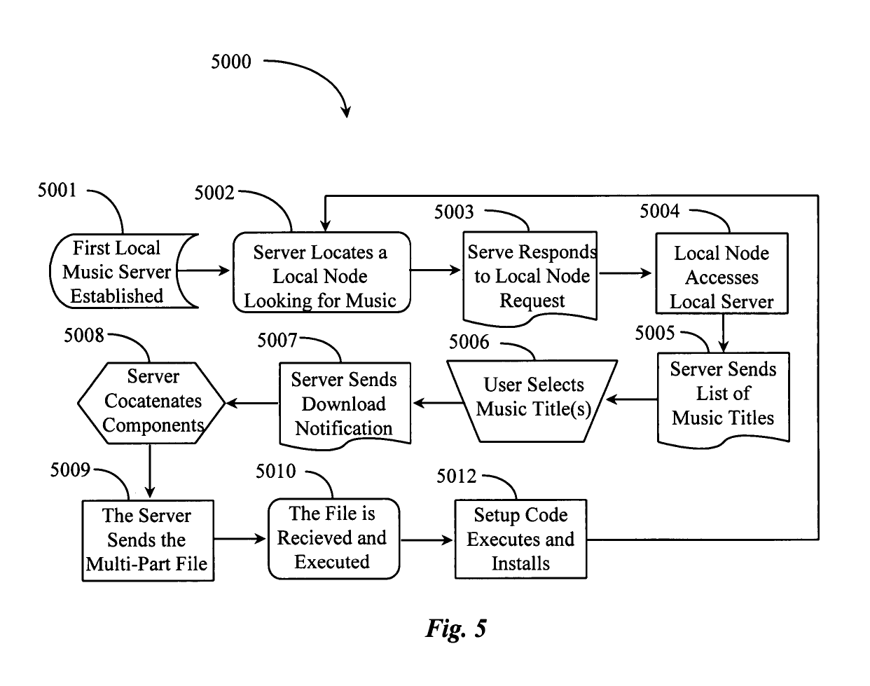

FIG. 5 is a process flow chart 5000 illustrating steps for practicing a music-sharing embodiment. The methods and apparatus may be applied in one form to a standard file-sharing embodiment whether the content is billable or freely downloadable. At step 5001, a first music server is established on the local network. At step 5002, the server locates a local node on the network that is actively looking for music. Step 5002 may be part of a proactive self-promotion process whereby the POD uses the interceptor logic to form connections databases and intercepts DNS requests or other data packets containing any indication that the node in question is looking for music. Typically, intercepting a request and responding to that request with relevant content may be considered less invasive than arbitrarily forcing the content on the user's system.

At step 5003, the server hosting the package responds to the local nodes request by sending the local node a popup or other notification including a hyperlink to the POD node. The original server the node was corresponding with may have its server connection reset. The POD is now emulating the original server the user intended to navigate to. Optionally at step 5004, the local target node may access the local POD server by clicking on the hyperlink inserted. Upon establishing the connection, at step 5005 the server may send a listing of available music titles to the target node. At step 5006, the user may optionally browse and select certain titles. At step 5007 the server may send a download notification window indicating that a download is about to occur.

At step 5008, the server concatenates all of the required components that will be distributed. This concatenation may include the setup files, the server, and finally the music files that were requested into a multipart file that may or may not be compressed. The multipart file created by the sever hosting the download may be executable automatically or through user invocation of the file such as by mouse click after download.

At step 5009, the server sends the multipart file to the targeted system. At step 5010, the multipart file is received and self-executes or is executed by the user. Upon execution at step 5010, the setup code executes and installs the server, installation code and or program, and finally the content if required. The process may revert back to step 5002 where the sever, then in cooperation with interceptor logic, looks for a new node to distribute to. The last node also begins this process. Using this process, local network users may quickly consume all of the music of one package originally obtained and served by one of the local nodes on the network. Many packages of music content may be quickly distributed in this manner.

Referring now back to the architecture of FIG. 1, mobile distributors may move content from one local network to another local network using wired and wireless LAN connections. In many instances, the distribution and installations may take place without any active connection between the local network and the WWW, which may be the original source of the content to be distributed. The users do not have to connect online and navigate to a central download server in a traditional sense in order to receive the content. The methods and apparatus of the present invention can also be practiced between multiple local networks that are bridged by a wide area connection such as a tunnel or virtual private network VPN connection.

The methods and apparatus of the present invention should be given the broadest scope under examination. The spirit and scope of the present invention is limited only by the following claims.

1. A system for promoting and distributing digital content over a data network comprising:
a source node connected to a data network;
a target node connected to the data network; and
a server application running on the source node for concatenating digital content for distribution to the target node;
Characterized in that the digital content distributed to the target node is a multipart file including at least an executable replication of the server application, an executable for installation of the digital content, and a module for promoting the existence of the content and new point of distribution thereof to at least one other target node.

2. The system of claim 1 wherein the data network is one of a local area network or a wireless local area network.

3. The system of claim 1 wherein the data network includes the Internet network and at least one local area network or wireless local area network.

4. The system of claim 1 wherein the source node and target node are computing stations.

5. The system of claim 1 wherein the source node is resident to a local area network and the target node is a wireless-capable node temporarily authorized to access the local area network.

6. The system of claim 1 wherein the source node is a router and the target node is a wireless computer and the network is a wireless LAN connected to the Internet network.

7. The system of claim 1 wherein the target node is a wireless computer having a wireless connection to a network other than the network that hosted the download to the target node.

8. The system of claim 7 wherein the network hosting the target node is a wireless fidelity network.

9. The system of claim 1 further comprising application logic for enabling proactive advertisement of the existence of the digital content the advertisement including the identification of the server of that content from the source node; and
a connections database built during active distribution listing the parameters of all active network connections on the local network.

10. The system of claim 9 wherein the advertisement received is an electronic display window received as a result of a browser action performed on the target node.

11. The system of claim 10 wherein the browser action is a domain name service request, the request intercepted by the source node using the application logic.

12. The system of claim 11 wherein the source node emulates the subject server node of the domain name request sent by the target node.

13. A multipart file capable of distributing versions of itself to multiple computing devices connected to a local area network comprising:
a server application for concatenating the file including a version of itself for distribution;
an installation code for installing the server application and other installable components of the multipart file to each subsequent computing device;
a file payload of useful digital content; and
application logic for building a database of network connections forged on the local network and for inserting content into those connections by emulating one party of those connections.

14. The multipart file of claim 13 wherein the file is self-executable upon download causing installation of the installable file portions and activation of further distribution efforts.

15. The multipart file of claim 13 wherein the local area network is an Ethernet network.

16. The multipart file of claim 13 wherein the local area network is a wireless network.

17. The multipart file of claim 13 wherein the file payload comprises one or more music files, video files, images, software updates to existing programs, software upgrades to existing programs, or new software programs.

18. A method for distributing digital content over a local network including steps of:
(a) intercepting a request to a server from a local node on the network;
(b) responding to the request by emulating the server and inserting information into the session, the information advertising the existence of the content for distribution and the network identification of the server of the content;
(c) receiving a request from the node responsive to the advertisement inserted;
(d) establishing a session with the local node and gathering information;
(e) concatenating the digital content including installation, logic, and server components into an executable multipart file; and
(f) sending the multipart file to the local node in a file download during the session.

19. The method of claim 18 wherein in step (a) the request is a domain name service request.

20. The method of claim 18 wherein in step (a) the local node is one of a resident computer, a wireless laptop, or a network-capable wireless telephony device.

21. The method of claim 18 wherein in step (b) the server connection is reset and emulation of the server is accomplished by generating a packet having the connection parameters of the sending server.

22. The method of claim 18 wherein in step (b) the inserted packet is an advertisement for the availability of the digital content including a hyperlink to the available content server.

23. The method of claim 18 wherein in step (d) the information gathered includes platform type, operating system type, and central processing unit type information.

24. The method of claim 18 wherein in step (e) the multipart file is compressed before send.

25. The method of claim 18 wherein in step (f) the multipart file self executes immediately after download is complete.

26. A method for distributing digital content over a local network including steps of:
(a) receiving a request to a POD from a local node;
(d) establishing a session with the local node and gathering information;
(e) concatenating the digital content including installation, logic, and server components into an executable multipart file; and
(f) sending the multipart file to the local node in a file download during the session.
